(19) United States
(12) Patent Application Publication
(10) Pub. No.: US 2022/0050034 A1
(43) Pub. Date: Feb. 17, 2022

(54) LOAD SIMULATION TEST STAND AND METHOD OF OPERATING SAME

(71) Applicant: UNIVERSITÄT PADERBORN, Paderborn (DE)

(72) Inventors: Karl-Peter JAEKER, Erwitte (DE); Ansgar TRAECHTLER, Paderborn (DE); Simon OLMA, Paderborn (DE); Andreas KOHLSTEDT, Paderborn (DE); Philipp TRAPHOENER, Bielefeld (DE)

(21) Appl. No.: 17/274,803

(22) PCT Filed: Nov. 25, 2019
(86) PCT No.: PCT/EP2019/082452

§ 371 Date: Mar. 10, 2021

(30) Foreign Application Priority Data
Nov. 30, 2018 (DE) 10 2018 009 386.8

(51) Int. Cl. G01N 3/10

(52) U.S. Cl. CPC G01N 3/10; G01N 2203/04; G01N 2203/0048; G01N 2203/0019

(57) ABSTRACT

The invention relates to a load simulation test stand having at least one hydraulic test cylinder (1) which comprises at least one cylinder chamber (1a, 1b) which can be charged with hydraulic fluid, preferably two cylinder chambers (1a, 1b) which can be charged with hydraulic fluid and which act counter to one another, in the case of which load simulation test stand the at least one test cylinder (1), in particular each of multiple provided test cylinders (1), comprises at least one capacity element (5, 6, 7), preferably a capacity element (5, 6, 7) which is exchangeable or which is adjustable in terms of hydraulic capacity, by means of which the hydraulic overall capacity of the at least one cylinder chamber (1a, 1b) can be adjusted. The invention furthermore relates to a method for operating a load simulation test stand having at least one test cylinder (1), wherein the at least one test cylinder (1) is connected to a load which is to be moved, and wherein the load is moved by means of a pressure control system (4) by temporally changeable control of the fluid pressure in the at least one cylinder chamber (1a, 1b) of the at least one test cylinder (1), and wherein, for the load which is to be moved by means of the at least one test cylinder (1), in a manner dependent on the pressure control bandwidth of the pressure control system (4), the natural frequency of the unit composed of the at least one test cylinder (1) and load is set to a value smaller than the pressure control bandwidth by changing the capacity of the capacity element (5, 6, 7), preferably adjusting the capacity of the adjustable capacity element (5, 6, 7).

The invention relates to A load simulation test stand comprising at least one hydraulic test cylinder having at least one, preferably two, hydraulic fluid compartments that can be acted upon with hydraulic fluid and that work against one another. The invention relates to furthermore a method of operating a load simulation test stand with at least one test cylinder, wherein the at least one test cylinder is connected to a load to be moved, with in particular the load attached to the piston rod of the test cylinder, and a pressure-control system moves the load by a time-changeable control of the fluid pressure in the at least one compartment of the at least one test cylinder, in particular according to a predetermined target movement.

Load simulation tests and methods for operating test stands are known in the prior art. Such load simulation test stands provide a mechatronic test stand used for highly dynamic load simulation, for example for investigation of operational strengths in vehicle axles.

Load simulation tests within the meaning of the invention are therefore preferably those test stands with which vehicle axles are stressed and their reaction to the load can be checked.

Load simulation tests can also be used for other applications.

Load simulation tests usually include at least one hydraulic test cylinder that is connectable to the load to move it defending on the pressure in the at least one pressurizable compartment. Here it is also known, for example to connect together several test cylinders as an excitation system. For example, a load can be moved by one or more hydraulic hexapods, each hydraulic hexapod having six hydraulic test cylinders. The connection of test cylinder and load takes place, for example, by the fact that the load is attached directly or by an adapter to the piston rod of the test cylinder.

Such test cylinders have at least one compartment and in a preferred application, two can be acted upon oppositely with hydraulic fluid via respective compartments against opposite piston faces of preferably the same area. Particularly preferably used test cylinders are thus synchronized cylinders for carrying out this procedure.

The pressure-control system for such a system works with a fluid pressure in the at least one compartment, preferably the pressures in the two compartments working against each other with time-changeable set points to regulate compartments and thereby move the load.

The pressure-control system can, for example, be a hydraulic pressure source, for example a pump and a sump, for example a tank. At least one reversible valve, preferably one valve per cylinder, controls the fluid pressure in the respective compartments, in particular in that the compartments are reversed by optional connection to the pressure source or sump.

In particular by applying pressure to oppositely effective compartments, for example in one synchronized cylinder, there is effectively a differential pressure control and thus a force control of the load exerted forces.

Conventional test cylinders that were previously used in such load simulation tests have a narrow control bandwidth, in particular that is less than a predetermined possible bandwidth of a pressure-control system, so that with conventional test cylinders a time curve of forces acting on the load for execution of a load simulation cannot be done in real time with a time modifiable pressure set points.

According to the current state of the art, this problem is avoided by using set points, for example of pressure, force, distance, or speed that are intended to move a load must be achieved and that must be used repeatedly with the control system of a load simulation test stand.

The control signals for control of the test cylinder or cylinders are changed depending on the metrological detection of the actual current movements of the load changed until the desired predetermined target movement is approximated sufficiently well through the iteration. The target movement to be achieved can be time-changing values to be achieved, for example for shifts and/or speeds or also the values of pressures or force. Such a target movement can be derived artificially or is a target movement that was specifically recorded by measurement, for example on a vehicle during actual street use, with the variables acting on the vehicle axle, for example forces and/or positions or changes in position or distance or speed of the load, for example the axle, are recorded. The effect of for example forces on the load, for example the axle, and the positions that change over time or speeds of components on the load, for example the axle or wheels, for example, define a possible target movement that is simulated with the load test stand.

Because of the iteration necessary to get to the target movement with which, for example the effect of the street is to be simulated on a vehicle axis, the load simulation based on the time required for the iteration cannot be done in not realtime, i.e. set points that change over time, for example the path or position (for example a component of the load) or the speed (for example of a component of the load) or force (between the load and test cylinder) or pressure (in the compartment) cannot be given to the control system in real time.

This proves that the technology of load simulation tests of the stand is not very flexible, for example when loads are changed, since for new loads, iterative testing is then repeated over and over again to determine the time change to be made to the set points. In addition, the previous load tests have the disadvantage that for the purpose of learning a concrete load can be used on the load simulation test bench which is already subject to high wear and tear during the learning process and in the worst case can even be destroyed. This leads to the need to carry out load simulations with several loads of the same type in order with at least one load to carry out the learning process and then carry out the simulation with at least one other load.

Against this background, it is an object of the invention to provide a load simulation test stand and a method of operating same, with which the effort can be reduced for load simulation of the movement or the action of force any load objects, such as vehicle axles, with preferably even the possibility that a given target movement of the load, such as for example simulated driving on a street with the to testing vehicle axle, is determined with set point values determined directly in real time i.e. preferably without repetition. The set points to be specified are preferred values of pressure (for example in the compartment) or path or position (for example of a component of the load) or speed (for example a component of the load) or force (for example between test cylinder and load).

Particularly preferably, an operating method of load testers opens up the possibility on the basis of measurement data from a test drive, for example recorded by measuring sensors for example for force, distance, speed or acceleration, for example when driving on a street with a vehicle axle to provide excitation signals, in particular set point values that change over time for a pressure-control system of a load test stand with which the measured measurement data can be generated in real time on a load attached to the load simulation test stand according to the invention. The pressure-control system can, for example, be a subordinate controller of a higher-level control structure, such as a cascade control or state control or be multisize control. Around the pressure-control system there can be for example path, speed or force control.

This object is attained with a load simulation test stand type as described above where the at least one test cylinder, in particular each of several test cylinders, comprises at least one capacity element, preferably a capacity element that is exchangeable or adjustable with respect to hydraulic capacity and with which the total hydraulic capacity of the at least one compartment is adjustable.

According to the invention, in a method of operating a load simulation test for at least one load to be moved by a test cylinder as a function of a predetermined load pressure-control bandwidth of the pressure-control system, the resonant frequency of the subassembly of test cylinder and load is set by changing the capacity of the capacity element, for example by exchange or preferably by adjusting the capacity of the adjustable capacity element to a value smaller than the pressure-control bandwidth.

The hydraulic capacity determines the compliance of system elements that, for example, is created by the compressibility of the hydraulic fluid, the elasticity of the piping or else the spring effect of a hydraulic accumulator.

Because of this resilience, a pressure change results in a volume change. The hydraulic capacity is defined as the proportional ratio of volume flow to pressure change. With a capacity element according to the invention, this relationship can be changed for at least one test cylinder, preferably for each of its compartments.

A pressure-control range of the pressure-control system being used is essentially predetermined by the system components used in the pressure-control system. For example, a pressure-control system can be used on a load simulation test stand with a pressure-control bandwidth of 120 Hz. This bandwidth is to be understood as an example. In principle, the pressure-control system can be a pressure-control bandwidth between 0 Hz and an upper cutoff frequency, so with such a pressure-control system, for example, typical movements of vehicle axles can be modeled theoretically, especially since it shows that usual frequency components in the movements, i.e. the paths or positions of a load, for example from vehicle axles are in the range from 0 to 60 Hz. Especially for the application in load simulation tests for the movement of vehicle axles therefore pressure-control ranges from 0 to 100 Hz or 0 to 120 Hz are sufficient. In particular, since the bandwidth has a lower limit frequency of 0 Hz it is essentially the value of the upper limit frequency of the pressure that is controlling.

The capacity element used according to the invention that the at least one compartment of the test cylinder is in fluid connection with makes it possible overall to adjust the total hydraulic capacity of the at least one compartment so that according to the invention the operating method uses the hydraulic total capacity to change a resonant frequency of the loaded test cylinder below the value of the upper limit frequency of the pressure-control system, and the pressure-controlled hydraulic test cylinder acts like an ideal band-limited pressure or force actuator.

A change in the total capacity can for example take place in that an existing capacity element is switched with another of a different capacity. The change in the total capacity is preferably effected by adjusting the capacity value of the capacity element itself, in particular, therefore, without having to optionally replace it. Thus it becomes preferred in this embodiment to use a capacity element whose own capacity can be adjusted, in particular at least within predetermined limits.

Due to the possibility of changing the total capacity of the at least one compartment, better control and bandwidth of the whole load simulation test is attained so that specified target movements of at least one test cylinder attached load can be determined either with fewer iterations or, particularly preferably, without any iteration, i.e. can be done in real time. By changing the pressure control set points over time, in the preferred embodiment directly without any iteration, the predetermined target movement of the load can be achieved, for example such a target movement that previously was recorded by an actual measuring session by measurement technology or also a target movement that was generated completely synthetically.

For example, the invention can provide here that a load test stand comprises at least one excitation system of test cylinders, e.g. at least one hydraulic hexapod accordingly has six hydraulic test cylinders and each hydraulic test cylinder according to the invention has at least one adjustable-capacity compartment because of an exchangeable or in capacity-adjustable capacity element that is in connection with the hydraulic fluid of the respective compartment.

The possibility of a predetermined target movement in specifying real-time operation also makes possible the use of load testers according to the invention for so-called hardware-in-the-loop techniques, such as the development of chassis control systems for motor vehicles.

According to the invention, it is preferred that each test cylinder of a load simulation test stand according to the invention has for each of its compartments a separate respective exchangeable or adjustable capacity element. This way each test cylinder can have its own separate inventive method steps, namely that after a change or adjustment of the capacity element or elements the resonant frequency of the unit of load and the at least one test cylinder is made smaller than the pressure-control bandwidth of the pressure-control system.

In general, the invention can provide that at least a capacity element, preferably each of the capacity elements of a respective test cylinder, is outside the respective test cylinder and in fluidic, especially direct fluidic connection with the compartment.

It is preferred that a direct fluidic connection effects a pressure drop in the connection between the compartment and the capacity element at the maximum frequency and the associated amplitude with which the test cylinder can or should be operated is no more than 10% of the impressed operating pressure.

In a preferred implementation of the invention, an external capacity element can be used that is, for example, a membrane expansion tank whose membrane has one side subject to the hydraulic fluid of the compartment while the other side is acted upon by a body of a fluid such as a gas. To control the capacity of the membrane expansion vessel, the gas pressure on the other side of the membrane is preferably adjustable. Thus changing the pressure in the fluid on the side of the membrane facing away from the hydraulic fluid or alternatively by switching it out for a vessel with another capacity the capacity of this membrane expansion tank reduces the resonant frequency of the load cylinder individually, in particular to attain a resonant frequency according to the above-described method below the pressure control cut-off frequency, for example less than 50 or 60 Hz.

An external capacity element can also be used, for example a stretchable hose, for example exchangeable and particularly preferred one that for adjustment of the capacity has an adjustable effective total hose length. For example, several hose sections of different lengths can be arranged in parallel or in series and connected together via respective valves so the effect of the stretchable hose optionally can be integrated or excluded form connection with the compartment. Thus one can choose between the various individual hose interconnections to combine various total hose lengths and thereby in turn adjust the resonant frequency of the load applied to at least one test cylinder.

There is also the possibility of a capacity element that is a body made of an elastomeric material, preferably by one provided with a closed cavity filled with a fluid, preferably a gas, so adjustment of the fluid pressure in the cavity of the elastomeric body is adjustable.

Generally and especially an external assembly of a further preferably adjustable capacity element on the at least one compartment of a respective test cylinder can be simply retrofitted to existing test cylinders from load simulation tests.

The invention can also provide that at least a capacity element, preferably each of the capacity elements, is provided inside the compartment of the respective test cylinder and acted on by the hydraulic fluid of the compartment. In this embodiment in particular it can it can be provided that the capacity element is resilient, for example made of an elastomeric material, preferably a hollow and fluid-filled body, where preferably the fluid pressure in the cavity of the body is adjustable. The adjustability of the fluid pressure in the cavity of this body is preferably internal even though the compartment can be mounted and controlled externally, for example via a corresponding line extending from the cylinder compartment.

Even when the capacity element is mounted internally, it can also be used, for example, as a membrane expansion tank with the hydraulic fluid of the compartment on one side of the membrane and its the other side acted upon by a fluid, in particular a gas whose pressure preferably can be adjusted to change the capacity value.

In principle, an internal capacity element can be provided for retrofitting existing test cylinders with such a capacity element.

Such a capacity element can be inside the test cylinder, for example serving as a stop for the piston of the test cylinder, for example to limit its range of motion. In particular, it is possible to for example replace the existing stops in a test cylinder with capacity elements according to the invention, preferably with other such elements of adjustable capacity.

It is essential to the invention that the resonant frequency of the assembly of the at least one test cylinder and the load be smaller than the pressure-control bandwidth of the pressure-control system. Preferably according to the invention, the resonant frequency to be selected is such that it corresponds to a value from 30% to 70%, preferably 40% to 60% and more preferably 45% up to 55% of the pressure-control bandwidth of the pressure-control system.

By adjusting the capacity to the resonant frequency values according to the invention, the method can operate the load simulation test so for example target fluid pressures are functions of a predetermined target movement that was for example previously measured or is generated synthetically directly, especially in real time. Thus target fluid pressure set points are specified in real time without a need to do this beforehand based on metrological detection of the movement of the load by iteration to approximate the given target movement, as known in the prior art.

With load simulation tests according to the invention and the operating method, loads can thus be more efficiently acted on especially without taking into account the time of an iteration and without it possibly caused damage to the load.

The invention is explained in more detail with reference to the attached figures in which:

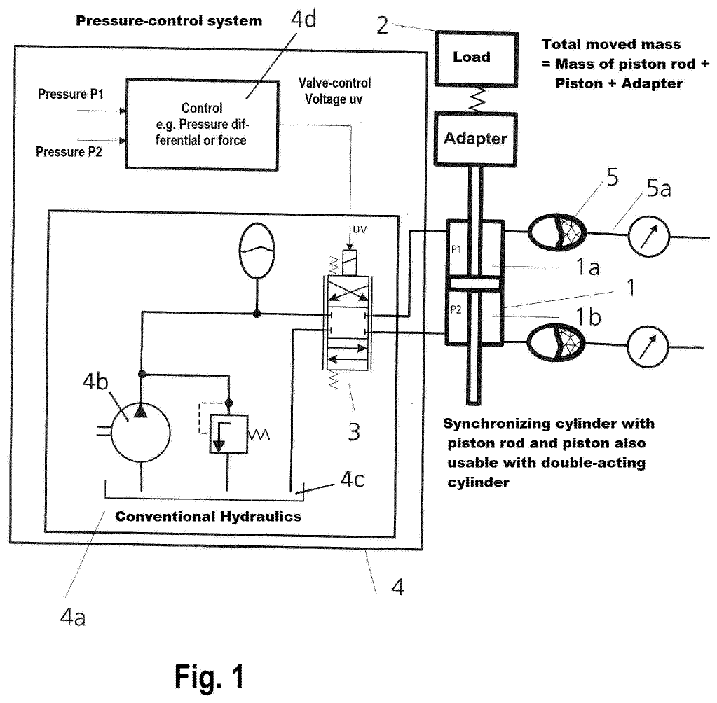

FIG. 1 shows an overall schematic view of a load simulation test stand that here, in particular for the sake of simplicity, has only one test cylinder 1. In actual practice it is however preferable to provide the load simulation test stand to operate with several such test cylinders 1, for example with several actuators for moving a load 2, including several test cylinders, as for example is the case with a hydraulic hexapod. In this example, the test cylinder 1 is a synchronized cylinder whose compartments 1a and 1b are controlled by a valve 3 of a pressure-control system 4 operated hydraulically by a hydraulic system 4a of the pressure-control system. A differential cylinder, for example, can also be used.

FIG. 1 shows that the load 2 here is attached via an adapter on the piston rod of the synchronizing cylinder, forming a jointly moving mass that is the sum of the masses of the piston rod, piston, adapter and the load 2 attached to it.

According to the invention, there is a respective external capacity element 5 for variably adjusting entire hydraulic capacity of each of the two compartments 1a and 1b. In this example the hydraulic capacity element 5 is a membrane expansion vessel where a face of the membrane turned away from the face subjected to the hydraulic fluid is pressurized via a line 5a. The membrane thus separates two compartments that, except for the membrane, are delimited by rigid walls. The ability to adjust the fluid pressure eliminates the need to change the capacity value of the membrane expansion tank against with another with a different capacity, which the invention, however, also includes.

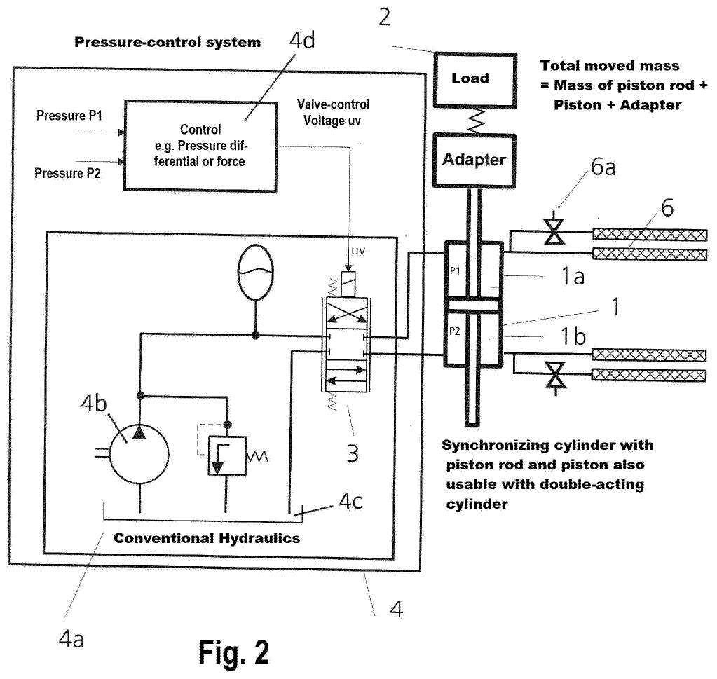

According to FIG. 2, the invention can also provide as alternative to the capacity element 5 of FIG. 1 a capacity element 6 that is structurally formed as an expansion tube, preferably as an assembly of at least two expansion hoses can be connected together by valves 6a optionally so that the effective total length of the stretchable hose can be optionally set.

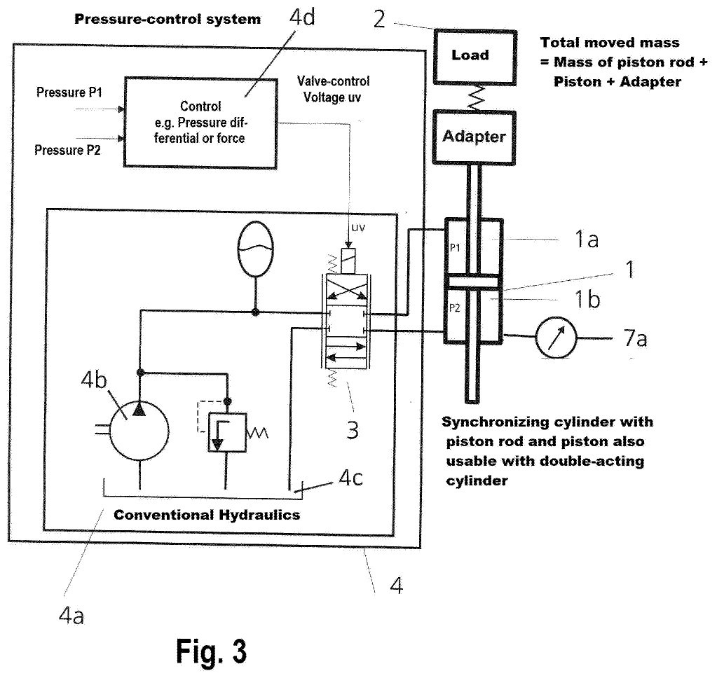

As a further alternative, according to FIG. 3 one of the compartments is for example provided with an elastomeric end stop 7 in direct fluid contact with the fluid are inside the compartment and preferably filled with a fluid, preferably a gas in a cavity whose the pressure of which can be changed via the line 7a.

FIGS. 1 to 3 each show essentially the same overall system, with only the capacity elements 5, 6, 7 different in type and preferably in each case in adjustable capacity. Instead of the alternative use these capacity elements can also be used cumulatively. And several different species capacity elements per compartment are possible.

For all possibilities of the realizable, preferred adjustable capacity elements, they are permanently connected to the respective compartments 1a and 1b and/or with the fluid of the respective compartment 1a, 1b. Consequently it is essential for the invention that a respective, preferably a capacity element that is adjustable in terms of the capacity is not separated from the cylinder by the valve 3 that is part of in pressure-control system for the application to the compartments of pressure which can be changed over time.

The pressure-control system here includes a reversible valve 3, with which the hydraulic fluid is supplied under pressure by a pump 4b from a tank 4c, and, depending on position, is fed into one of the two compartments 1a or 1b and at the same time is returned from the other compartment to the tank 4c.

The valve is controlled by control electronics 4d using pressure sensors to record the pressure P1 or P2 in the compartments 1a and 1b and compare these pressure as actual values with the target value and from this control the valve 3.

This described pressure control described can be part of an overriding further control that is not shown here and that regulates another variable, for example the movement or the position or speed of the load.

By changing the hydraulic capacity of the respective capacity element 5, 6 or 7 by exchanging the capacity elements against those of other capacities or by adjusting its own capacity, the resonant frequency of the entire assembly of the test cylinder and its load 2 for each cylinder chamber 1a, 1b is set to a value smaller than the control bandwidth of the pressure-control system 4, in particular as required by the system.

For example, the pressure-control bandwidth can be a system constant determined by the elements of the pressure-control system. In recognition of this pressure-control bandwidth and, in particular, therefore the upper limit frequency that this pressure-control system can reach, the resonant frequency of the assembly of the load and the load test cylinder can now be determined are selected so that the resonant frequency is smaller than the upper frequency limit and preferably in the range from 30% to 70%, more preferably 40% to 60% and particularly preferably 45% to 55% of the pressure-control bandwidth or the upper frequency limit.

1. A load simulation test stand comprising a hydraulic test cylinder having two hydraulic fluid compartments that can be acted upon with hydraulic fluid and that work against one another, wherein the test cylinder comprises a capacity element that is exchangeable or adjustable with respect to hydraulic capacity and with which the total hydraulic capacity of the compartment is adjustable.

2. The load simulation test stand according to claim 1, wherein the test cylinder has for each of its compartments a separate adjustable capacity element.

3. The load simulation test after claim 1, wherein the capacity element is external to the respective test cylinder and in direct fluidic connection to the compartment.

4. The load simulation test stand according to claim 3, characterized that the external capacity element of the test cylinder is formed as:
a membrane expansion tank having a membrane with one side acted on by the hydraulic fluid of the compartment and an opposite side movable by a gas, whose pressure can be adjusted to change the capacity value, or
an expansion hose assembly, preferably whose effective total hose length is adjustable, or
a resilient assembly made of an elastomeric and fluid-filled body, the fluid pressure in the cavity of the body is adjustable.

5. The load simulation test according to claim 1, wherein the capacity element, preferably each of the capacity elements, is in the compartment of the test cylinder and is acted on by the hydraulic fluid of the compartment.

6. The load simulation test stand according to claim 5, wherein the internal capacity element of the test cylinder is formed as:
a elastomeric hollow fluid-filled body in which fluid pressure in a cavity of the body is adjustable, or
a membrane expansion tank whose the membrane has one to side acted upon by the hydraulic fluid of the compartment and an opposite other side acted upon by a gas, whose pressure is adjustable to change the capacity value.

7. A method of operating a load simulation test stand comprising a test cylinder according to one of the previous claims, wherein the test cylinder is connected to the load to be moved and a pressure-control system with a time-changeable control of the fluid pressure in the compartment of the test cylinder moves the load, wherein for the load being moved by the test cylinder depending on the load pressure-control bandwidth of the pressure-control system, the resonant frequency of the assembly of the test cylinder and load is set by setting the capacity of the adjustable-capacity element to a value smaller than the pressure-control bandwidth.

8. The method according to claim 7, wherein the resonant frequency is set to a value of 30% to 70%, of the pressure-control bandwidth.

9. The method according to one of the preceding claim 7, wherein target fluid pressure set points of the pressure-control system in dependence on a given target movement of the load are determined directly in real time without the target fluid pressure set points being previously determined by metrological detection of the movement of the load to approach the specified target movement with iteration.
